(19) United States
(12) Patent Application Publication
(10) Pub. No.: US 2016/0058061 A1
(43) Pub. Date: Mar. 3, 2016

(54) DELAYING OXIDATION IN FOOD SYSTEMS BY USE OF LIPID SOLUBLE TEA CATECHINS

(71) Applicant: Kemin Industries, Inc., Des Moines, IA (US)

(72) Inventors: Julianne Drury, Ankeny, IA (US); Joan Randall, Ames, IA (US); Lan Ban, West Des Moines, IA (US); William Schroeder, Ames, IA (US)

(21) Appl. No.: 14/841,129

(22) Filed: Aug. 31, 2015

Related U.S. Application Data
(60) Provisional application No. 62/043,690, filed on Aug. 29, 2014.

(51) Int. Cl. A23L 3/3508

(52) U.S. Cl. CPC A23L 3/3508; A23V 2002/00

(57) ABSTRACT

Lipid soluble tea catechins are found useful in delaying undesirable changes in the color and extending the oxidative stability of meat products, food emulsions and extruded foods. This composition has shown to be effective in maintaining the desirable red color of the meat products, as well as delaying the formation of oxidative byproducts, when compared to untreated meat products, maintaining the low oxidative products in food emulsions and maintaining the low secondary oxidative products and acceptable sensory profiles in extruded foods. This composition also has shown to be effective in delaying the formation of oxidation products in margarine and salad dressing.

This application claims priority to U.S. Patent Application 62/043,690, filed Aug. 29, 2014, which is incorporated herein in its entirety by this reference.

### BACKGROUND OF THE INVENTION

The present invention relates generally to the use of catechins extracted from tea that have been esterified to produce lipid soluble tea catechins esters found to be efficacious in delaying oxidation in food products.

While water soluble green tea catechins are widely used to serve antioxidant functions, their application is limited in high fat food matrices. The active compounds in lipid soluble tea catechins (LSC), catechin esters, share the catechin functional moieties which are excellent free radical scavengers to serve as an antioxidant. The oil solubility of catechin esters has been improved by the addition of long alkyl chains from the palmityl functional group, thus making them more appropriate and effective for higher fat matrices. One advantage of LSC is its lower flavor profile which enables it to be used at higher treatment levels than certain other botanical extracts, such as rosemary extract, with increasing efficacy.

In addition, although LSC is lipid soluble, it also serves as an effective ingredient in protecting food emulsions and meat because LSC is hypothesized to participate in the interface of the lipid and water phases present in these products. Because the rate of oxidation is highest at the interface, and LSC is localized and would be able to maximize its function in stabilizing fats and delays the formation of oxidation byproducts.

### SUMMARY OF THE INVENTION

This invention describes the use of lipid soluble tea catechins in delaying undesirable changes in the color and extending the oxidative stability of meat products, food emulsions and extruded foods. This composition has shown to be effective in maintaining the desirable red color of meat products as well as delaying the formation of oxidative byproducts when compared to untreated meat products, delaying the formation of oxidative products in food emulsions and maintaining acceptable sensory profiles in extruded foods.

LSC has been used in straight fats and oils in some places because lipid soluble tea catechins could protect lipids from oxidation. However, it is novel that in this invention, LSC has been used in food emulsions, meat products and low-fat cereals. Due to the molecular structure of LSC, it would participate at the interface of lipids and water phase, which would maximize its antioxidant function. This hypothesis has been backed up by the data presented in this invention.

The obvious application of LSC was to use it in straight fats and oils. It is not obvious that LSC has better antioxidant functions in meat, food emulsions and low-fat extruded foods. LSC can be used at a variety of treatment levels and as a combination product with other ingredients including rosemary extract and mixed tocopherols.

A purpose of the present invention is to provide a method of delaying oxidation in food products having a lipid and water phase interface, comprising the step of admixing an efficacious amount of tea catechins esterified to palmityl esters

### BRIEF DESCRIPTION OF THE FIGURES

FIG. 1 is a chart of peroxide values (meq/kg fat) over time in mayonnaise with the recited treatments.

FIG. 2 is a chart of alkenals (nmol/ml) over time in mayonnaise with the recited treatments.

FIG. 3 is a chart of peroxide values (meq/kg fat) in cereal which was stored at 40° C.; error bars represent standard deviation from two batches.

FIG. 4 is a chart of hexanal values (ppm) in the cereals which were stored at 40° C.; error bars represent standard deviation from two batches.

FIG. 5 is a chart of peroxide values (meq/kg fat) of margarine during 35° C. storage.

FIG. 6 is a chart of p-Anisidine values of margarine during 35° C. storage.

FIG. 7 is a chart of alkenals (nmol/ml) of ranch dressing at accelerated storage.

FIG. 8 is a chart of peroxide values (meq/kg fat) of ranch dressing at accelerated storage.

FIG. 9 is a chart of the volume fraction of emulsion phase affected by the addition of oil-in-water emulsifiers including span 80, TGDO and LSC.

### DETAILED DESCRIPTION OF THE PREFERRED EMBODIMENTS

### Definitions

Before explaining the various embodiments of the disclosure, it is to be understood that the invention is not limited in its application to the details of construction and the arrangement of the components set forth in the following description. Other embodiments can be practiced or carried out in various ways. Also, it is to be understood that the phraseology and terminology employed herein is for the purpose of description and should not be regarded as limiting.

Throughout this disclosure, various publications, patents and published patent specifications are referenced. Where permissible, the disclosures of these publications, patents and published patent specifications are hereby incorporated by reference in their entirety into the present disclosure to more fully describe the state of the art.

To facilitate understanding of the disclosure, the following definitions are provided:

The amount of the compositions of the present invention to be used in particular applications according to the invention may be readily determined by a person skilled in the art, as a function of the nature of the composition used and/or the desired effect. In general, this amount may be between 0.01% and 2% by weight relative to the total weight of the food product being treated, in particular between 0.2% and 1.5% by weight, preferably between 0.5% and 1% by weight and preferentially between 0.6% and 0.9% by weight.

In preferred embodiments of the present invention, the efficacious amount of a blend of lipid soluble catechins ranges from 10 ppm and 5,000 ppm by weight of the products being treated and all values between such limits, including, for example, without limitation or exception, 0.02%, 0.104%, 0.132%, 0.217%, 0.336%, 0.489%, 1.377% and 1.990%. Stated another way, in preferred embodiments of the invention, the dosage can take any value “abc0” ppm wherein a is selected from the numerals 0, 1, 2, 3, 4 and 5, and b and c are each individually selected from the numerals 0, 1, 2, 3, 4, 5, 6, 7, 8 and 9, with the exception that c cannot be less than 1 if a and b are both 0.

Where ranges are used in this disclosure, the end points only of the ranges are stated so as to avoid having to set out at length and describe each and every value included in the range. Any appropriate intermediate value and range between the recited endpoints can be selected. By way of example, if a range of between 0.1 and 1.0 is recited, all intermediate values (e.g., 0.2, 0.3. 6.3, 0.815 and so forth) are included as are all intermediate ranges (e.g., 0.2-0.5, 0.54-0.913, and so forth).

As used herein, the singular forms “a,” “an,” and “the” include plural referents unless the context clearly dictates otherwise. Thus, for example, reference to “a factor” refers to one or mixtures of factors, and reference to “the method of treatment” includes reference to equivalent steps and methods known to those skilled in the art, and so forth.

The term “antioxidant” as used herein refers to a composition which prevents or delays the oxidation of food products. Antioxidants are generally classified as either synthetic or natural. Antioxidants include, but are not limited to, BHA, BHT, tert-butlyhydroquinone (TBHQ), gallates, ascorbic acid, erythorbic acid, ascorbyl palmitate, tocopherols, tocotrienols, carotenoids, anthocyanins, polyphenols, citric acid, ethoxyquin, EDTA, glycine, lecithin, polyphosphates, tartaric acid, trihydroxybutyrophenone, thiodipropionic acid, and dilauryl and distearyl esters.

The term “efficacious amount” or “effective amount” refers to an amount effective, at dosages and for periods of time necessary, to achieve the desired result. The effective amount of compositions of the invention may vary according to factors such as the composition or formulation of the product being treated with the methods and/or compositions of the present invention.

The term “emulsion” refers to a mixture prepared from two mutually insoluble components. It is possible to generate mixtures of homogenous macroscopic appearance from these components through proper selection and manipulation of mixing conditions. The most common type of emulsions are those in which an aqueous component and a lipophilic component are employed and which in the art are frequently referred to as oil-in-water and water-in-oil emulsions. In oil-in-water emulsions the lipophilic phase is dispersed in the aqueous phase, while in water-in-oil emulsions the aqueous phase is dispersed in the lipophilic phase.

The term “catechins” refers to polyphenolic compounds present in the leaves of Camellia sinensis. Green tea polyphenols include, but are not limited to (−)-epicatechin (EC), (−)-epigallocatechin (EGC), (−)-epicatechin-3-gallate (ECG), (−)-epigallocatechin-3-gallate (EGCG), proanthocyanidins, enantiomers thereof, epimers thereof, isomers thereof, combinations thereof, and prodrugs thereof. Lipid soluble tea catechins refers to a green tea polyphenols esterified to have one or more hydrocarbon chains, for example C1 to C30. Lipid soluble tea catechins specifically include the esterification reaction products of tea catechins with saturated and unsaturated C1-C30 fatty acids.

“Lipid soluble” as used herein refers to substances that have a solubility of greater than or equal to 5 g/100 ml in a hydrophobic liquid such as castor oil.

“Margarine” as used herein refers to an imitation butter spread comprising vegetable oil and water and consisting of a water-in-fat emulsion.

“Oxidative or oxidation stability” as used herein is a measure of a food product's resistance to oxidation.

“Water soluble” as used herein refers to substances that have a solubility of greater than or equal to 5 g/100 ml water.

### Example 1

### Meat

The shelf life of processed meats is limited by microbial spoilage and oxidative rancidity. Lipid oxidation is responsible for undesirable flavor and color changes, and is the primary mode of failure for frozen meats. Natural extracts derived from plant materials have been shown to delay these oxidative changes. Finely textured pork (FTP) is made from pressing/grinding pork shoulder bones to retrieve protein from the bones. The FTP is then heated to around 50° F. after pressing, placed into 50 lb boxes, palletized and sent to a blast freezer. Due to the abusive processing parameters, the current shelf life is 20 days frozen and the desired shelf life is 30-45 days for a customer to consider using this ingredient in pepperoni (at 10-15% of meat block). The gold standard would be 45 days. The objective of this study was to evaluate the impact of various treatments including FORTIUM®_{brand} R30 liquid (rosemary extract/sunflower oil), FORTIUM®_{brand} RGTWS 1200 Liquid (rosemary/green tea extract/polysorbate 80/glycerol monooleate/propylene glycol), FORTIUM®_{brand} R-WS 20 Liquid (rosemary extract/polysorbate 80/glycerol monooleate/propylene glycol) and GT-FORT 101 SF Liquid (lipid soluble tea catechins/sunflower oil) (all of which were sourced from Kemin Industries, Inc., Des Moines, Iowa) on the quality attributes of FTP.

### Materials and Methods

Materials.

Frozen FTP was provided by a customer. The products used in the treatment of the FTP were obtained internally. The following treatments were prepared 1) untreated, 2) FORTIUM®_{brand} R30 0.1% (lot 1403102012) (R30), 3) FORTIUM®_{brand} RGTWS 1200 0.25% (lot 1309102599) (RGT-WS 1200), 4) FORTIUM®_{brand} R-WS 20 0.25% (lot 1402109597) (R-WS 20) and 5) GT-FORT™ 101 SF Liquid 0.3% (lot 20140326-01). All treatments were based on the total weight of the pork.

Mixing Instructions.

A KitchenAid® mixer (325 watt, St. Joseph, Mich.) and stainless steel bowls were placed in the walk-in cooler (37° F.) to chill. The FTP was allowed to thaw at refrigerated temperature (37° F.) before being divided among the 5 treatments. FTP (900 grams) was weighed for each batch. Fifty grams were removed and the remaining 850 grams was placed into the chilled mixer bowls. The treatments were mixed by hand into the reserved 50 grams of FTP (approximately 2 min). The bowl was placed on the mixer stand and the mixing speed set at 3. The 50 grams of treated FTP was added to the remaining 850 grams and mixed for 2-3 minutes with the paddle attachment. After mixing, the chilled bowl with the treated FTP was placed onto a Chilzstone (Castle Rock, Colo.) cooling tray and 30-40 gram samples were placed into 18 oz Whirl-Pak™ bags (Fisher Scientific catalog #018125B). As each bag was filled it was smoothed, flattened, sealed and placed on another Chilzstone to freeze. Samples were stored at 1° F. in a cardboard box for the frozen study and 36° F. for the refrigerated study.

Chemical and Physical Analyses.

Treated FTP was evaluated for oxidative byproducts (malonaldehydes) using thiobarbituric acid reactive substances (TBARS) and L*a*b* color values (Hunter Colorimeter).

Stability Analysis.

Stability testing on frozen samples was performed twice weekly for the first 2 weeks for TBARS, thereafter, testing was performed every 7 days. Color analysis was performed twice a week for 4 weeks, thereafter, every 7 days for a total of 63 days. Color analysis was performed on refrigerated samples on the day of removal from the freezer (initial) and after 4 days refrigerated storage.

### Results

Frozen Storage.

The results of the TBARS analysis are shown in Table 1. With the exception of days 14 and 21, the untreated sample was the highest in oxidative byproducts.

TABLE 1
TBARS (mg/kg) results of FTP (days)

| Treatment | Initial | 3 | 7 | 10 | 14 | 21 | 28 | 35 | 42 | 49 | 57 | 64 |
|---|---|---|---|---|---|---|---|---|---|---|---|---|
| Untreated | 1.40 | 1.43 | 1.68 | 1.36 | 1.29 | 2.39 | 1.93 | 1.79 | 3.17 | 4.13 | 2.91 | 3.38 |
| R30 0.1% | 1.09 | 1.14 | 1.40 | 1.14 | 1.12 | 3.07 | 1.23 | 0.90 | 1.11 | 1.26 | 1.00 | 0.46 |
| RGT-WS1200 | 1.10 | 1.01 | 1.05 | 1.04 | 1.53 | 1.88 | 1.25 | 0.92 | 1.14 | 1.22 | 0.87 | 0.44 |
| 0.25% | | | | | | | | | | | | |
| R-WS20 | 1.01 | 1.17 | 1.08 | 1.15 | 1.68 | 2.16 | 1.14 | 0.94 | 1.08 | 1.29 | 1.06 | 0.50 |
| 0.25% | | | | | | | | | | | | |
| GT-FORT 101 | 1.04 | 1.08 | 1.20 | 1.21 | 1.92 | 1.30 | 1.43 | 1.47 | 1.30 | 1.32 | 1.35 | 0.39 |
| SF 0.3% | | | | | | | | | | | | |

The results of the color analysis are shown in Tables 2, 3 and 4. L* values indicate lightness/darkness of a sample (0=black, 100=white), a* values indicate red/green (+ indicates more red, − indicates more green) and b* values indicate yellow/blue (+ indicates more yellow, − indicates more blue). Hunter a* values were considered the most relevant for this matrix. The percentage change from initial to day 63 was untreated (−20.88), R30 (−4.08), R-WS 20 (−4.75), RGTWS 1200 (+1.14) and LSC (−14.75).

TABLE 2
L* values of FTP

| | | | | | GT-FORT |
|---|---|---|---|---|---|
| | Untreated | R30 | R-WS 20 | RGT-WS 1200 | 101 SF |
| Initial | 49.92 | 46.49 | 47.74 | 47.15 | 43.57 |
| Day 3 | 49.08 | 42.95 | 44.58 | 43.09 | 44.52 |
| Day 7 | 49.46 | 50.01 | 49.29 | 49.17 | 44.07 |
| Day 10 | 47.31 | 48.22 | 50.70 | 48.79 | 47.22 |
| Day 14 | 50.67 | 50.01 | 49.29 | 49.17 | 44.07 |
| Day 17 | 45.63 | 41.65 | 43.17 | 42.95 | 42.48 |
| Day 21 | 47.95 | 48.14 | 45.54 | 47.81 | 44.80 |
| Day 24 | 48.43 | 44.40 | 44.99 | 46.92 | 44.93 |
| Day 28 | 47.98 | 41.44 | 41.72 | 42.07 | 41.22 |
| Day 35 | 45.27 | 47.80 | 47.98 | 44.35 | 44.77 |
| Day 42 | 45.66 | 45.60 | 43.96 | 45.66 | 44.70 |
| Day 49 | 48.90 | 43.84 | 40.61 | 40.45 | 39.06 |
| Day 57 | 47.19 | 41.10 | 46.56 | 42.79 | 40.53 |
| Day 63 | 42.50 | 42.02 | 41.32 | 42.40 | 42.53 |

TABLE 3
a* values of FTP

| | | | | | GT-FORT |
|---|---|---|---|---|---|
| | Untreated | R30 | R-WS 20 | RGT-WS 1200 | 101 SF |
| Initial | 35.81 | 31.59 | 33.25 | 30.68 | 34.23 |
| Day 3 | 33.20 | 35.56 | 37.22 | 35.45 | 36.42 |
| Day 7 | 34.79 | 30.69 | 31.94 | 31.34 | 35.05 |
| Day 10 | 37.39 | 32.48 | 30.04 | 29.63 | 32.95 |
| Day 14 | 34.36 | 30.69 | 31.94 | 31.34 | 35.05 |
| Day 17 | 34.80 | 35.10 | 33.66 | 34.45 | 35.04 |
| Day 21 | 33.05 | 29.43 | 30.93 | 28.76 | 31.50 |
| Day 24 | 33.32 | 33.30 | 31.66 | 29.36 | 33.55 |
| Day 28 | 28.37 | 29.14 | 30.27 | 28.27 | 29.16 |
| Day 35 | 28.38 | 28.62 | 27.48 | 28.67 | 32.14 |
| Day 42 | 33.87 | 28.23 | 30.29 | 27.86 | 31.26 |
| Day 49 | 30.36 | 29.39 | 32.77 | 30.89 | 31.79 |
| Day 57 | 29.08 | 32.65 | 26.15 | 31.32 | 34.63 |
| Day 63 | 28.33 | 30.30 | 31.67 | 31.03 | 29.18 |

TABLE 4
b* values of FTP

| | | | | | GT-FORT |
|---|---|---|---|---|---|
| | Untreated | R30 | R-WS 20 | RGT-WS 1200 | 101 SF |
| Initial | 30.41 | 27.01 | 25.98 | 23.75 | 26.11 |
| Day 3 | 26.98 | 30.17 | 30.09 | 26.75 | 30.67 |
| Day 7 | 27.71 | 24.94 | 25.07 | 24.38 | 29.08 |
| Day 10 | 30.61 | 26.16 | 23.44 | 22.98 | 26.04 |
| Day 14 | 27.48 | 24.94 | 25.07 | 24.38 | 29.08 |
| Day 17 | 30.37 | 30.80 | 29.41 | 28.78 | 31.48 |
| Day 21 | 27.93 | 25.08 | 24.24 | 21.65 | 26.33 |
| Day 24 | 26.95 | 24.77 | 25.70 | 24.80 | 28.30 |
| Day 28 | 22.04 | 21.08 | 21.35 | 18.93 | 19.93 |
| Day 35 | 25.79 | 23.71 | 22.28 | 24.05 | 26.37 |
| Day 42 | 28.34 | 23.77 | 25.30 | 20.74 | 27.42 |
| Day 49 | 27.48 | 24.73 | 28.69 | 25.54 | 25.56 |
| Day 57 | 22.96 | 27.08 | 20.48 | 26.06 | 29.91 |
| Day 63 | 26.21 | 28.11 | 27.09 | 27.40 | 25.55 |

Refrigerated Storage.

The Hunter Colorimeter results of the refrigerated storage are shown in Tables 5, 6 and 7. All samples had higher L* values and lower a* values at day 4 compared to the initial test indicating they had become lighter and less red. By day 7, the samples had spoiled so no further evaluations were performed.

TABLE 5
L* value of FTP

| | | | | | GT-FORT |
|---|---|---|---|---|---|
| | Untreated | R30 | R-WS 20 | RGT-WS 1200 | 101 SF |
| Initial* | 42.50 | 42.02 | 41.32 | 42.40 | 42.53 |
| Day 4 | 47.74 | 45.37 | 46.83 | 46.66 | 46.05 |

*initial values are from day 63 frozen storage

TABLE 6
a* value of FTP

| | | | | | GT-FORT |
|---|---|---|---|---|---|
| | Untreated | R30 | R-WS 20 | RGT-WS 1200 | 101 SF |
| Initial | 28.33 | 30.30 | 31.67 | 31.03 | 29.18 |
| Day 4 | 8.78 | 28.21 | 24.32 | 23.59 | 24.93 |

TABLE 7
b* value of FTP

| | | | | | GT-FORT |
|---|---|---|---|---|---|
| | Untreated | R30 | R-WS 20 | RGT-WS 1200 | 101 SF |
| Initial | 26.21 | 28.11 | 27.09 | 27.40 | 25.55 |
| Day 4 | 18.34 | 29.50 | 24.36 | 23.61 | 26.27 |

Visual evaluation showed that the untreated sample had lost the desirable red color compared to all treated samples.

### Discussion

For frozen storage from day 28 onwards the untreated sample had the highest TBARS compared with all treated samples being considerably lower. At the last frozen TBARS analysis (day 64) all treated samples had similar oxidative byproduct results indicating that all treatments were effective and had similar efficacy in delaying oxidative rancidity when compared to the untreated sample. Hunter Colorimeter analysis show that the untreated sample had the highest decrease in a* values from initial to day 63 of frozen storage indicating all treatments maintained more of the desirable red color more effectively than the untreated sample. For refrigerated storage, there were obvious visual differences between the untreated and treated samples indicating that the treatments were all effective in maintaining a more desirable red color.

These results show that using FORTIUM®_{brand} R30, FORTIUM®_{brand} R-WS 20, FORTIUM®_{brand} RGTWS 1200 or LSC in FTP delays the formation of oxidative byproducts and maintains a more desirable color resulting in a longer shelf life.

### Example 2

### Mayonnaise

Mayonnaise was produced in-house and treated with FORTIUM®_{brand} R30 (rosemary extract/sunflower oil) (R30), lipid soluble catechins (LSC), and Ethylenediaminetetraacetic acid (EDTA) (as positive control), as well as an untreated negative control and stored under ambient conditions. The oxidation of the mayonnaise was monitored by testing peroxide value (PV) and alkenals monthly for 4 months. The results showed that LSC and EDTA treated mayonnaise both resulted in lowest amount of oxidation products throughout the test period, indicating that LSC may be useful as a replacement for EDTA in mayonnaise.

### Materials and Methods

Mayonnaise Production.

To make the mayonnaise (see Tables 8 and Table 9), the egg yolks were first whipped in a KitchenAid® mixer (Heavy Duty) using the wire whip attachment for 30 seconds on setting #2. Salt and mustard were added, and mixed for an additional 30 seconds on setting #4. The sides were scraped with a spoon 3 times. The water was then added and mixed for 30 seconds on setting #2. The side was scraped again. Then the mixture was mixed for another 30 seconds on setting #4. The soybean oil was added very slowly while mixing at #4, in small increments (especially at first, when only a few milligrams of oil were added and allowed to absorb in the mixture before adding more). Towards the end, it was added in a slow stream. Once the oil was all added, the vinegar was added over 30 seconds while mixing on setting #2. The resulting mixture was mixed for an additional 30 seconds, alternating between setting #2 and setting #4. The total mixing time is 5-10 minutes for each batch.

Application of Antioxidants.

Three treated batches of mayonnaise were produced and one untreated control was also made as comparison. Each batch contained 1500 g mayonnaise. The treatments included A. 500 ppm of R30 (0.7501 g added to the oil); B. 250 ppm LSC (0.3752 g added to the oil); C. 75 ppm EDTA (0.1131 g added to the water). The dosage of EDTA is the upper legal limit that is allowed to be added in mayonnaise in US.

Sampling and Testing.

Eight 100 g samples were placed into individual 125 ml plastic bottles for each batch. The bottles were kept on an open shelf in the lab at ambient temperature for 4 months. At the end of each month, one bottle from each batch was placed into a −20° C. freezer overnight, and thawed the following day to room temperature to break the emulsion. If the emulsion was still stable after freezing/thawing, a sample from the emulsion was transferred to a centrifuge tube and centrifuged at 10,000 rpm for 10 minutes. After the emulsion was broken, there were two liquid phases. The resulting oil phase (the upper layer) was used for peroxide value (PV) and alkenals analyses.

PV and Alkenals Analysis.

For PV/alkenals analysis, 1.00±0.01 g of oil was transferred into a 15 ml centrifuge tube (Thermo Scientific, Catalog #362694). The tests followed established methods. The reagents used for the analysis are summarized in Table 10. Briefly, 9.0 ml of Preparation Reagent (made from adding 3.87 g of butylated hydroxytoluene into 4 L of isopropanol) was added to each tube. The sample was vortexed (Fisher Digital Vortex Mixer, Catalog #120123017) for 1 minute, and then centrifuged at 4000 rpm for 5 minutes (Sorvall ST16 centrifuge, Thermal Scientific). The supernatant was used for the analyses.

For PV analysis (which measures primary oxidation products), 100 μl of the supernatant was added to a glass test tube (12×75 mm). One aliquot (3.5 ml) of the Preparation Reagent was added. Then 400 μl Xylenol Orange indicator solution was mixed with the solution. The mixture was vortexed briefly and was placed on a rocker. After exactly 5 minutes later the sample was read using the 570/690 nm filter on a MicroChem II Spectrophotometer to obtain PV from FOX II method. For alkenals analysis of the mayonnaise (which measures secondary oxidation products), 150 μl of the supernatant was added to a glass test tube (12×75 mm). One aliquot of each AlkalSafe (MP Biomedicals) Reagent A and B were dispensed. Samples were vortexed and allowed to stand 20 min, then read using the 550 nm/690 nm filter on a MicroChem II Spectrophotometer using the Alk/Std method. A standard curve was also prepared using this method.

TABLE 8
Ingredients used to make the mayonnaise.

| Ingredient | Lot | Source |
|---|---|---|
| Lipid Soluble Green | #1301108643 | Kemin Food Technologies |
| Tea Extract (LSC) | | |
| Calcium Disodium EDTA | #C060131 | Premium Ingredients Intl, |
| | | Carol Stream, IL |
| FORTIUM ®_{brand} R30 | unknown | Kemin Food Technologies |
| Soybean oil | #1402109973 | Kemin RM 01320 |
| Table salt | N/A | Morton's |
| Pasteurized frozen | #038V3-1 | Oskaloosa Foods, |
| egg yolks (10% salt) | | complimentary |
| Ground mustard | N/A | Tone's ® (ACH Food |
| | | Companies) |
| Distilled white vinegar, | N/A | Heinz ® |
| acidity 4.5-5.0% | | |
| Water | N/A | Crystal Clear ®, bottled |

TABLE 9
Mayonnaise formula per batch.

| Ingredient | Target % | Mass added |
|---|---|---|
| Soybean oil | 75.00 | 1125 ± 0.05 g |
| Salt | 0.61 | 9.18 ± 0.01 g |
| Egg yolks, 10% salt | 8.89 | 133.32 ± 0.05 g |
| Ground mustard | 1.00 | 15 ± 0.01 g |
| Heinz ® distilled white vinegar | 12.60 | 189 ± 0.01 g |
| Water | 1.90 | 28.5 ± 0.01 g |

TABLE 10
Chemicals used for PV/alkenals analysis.

| Chemical | Supplier | CAS # | Lot # |
|---|---|---|---|
| Butylated hydroxytoluene (BHT) | Acros Organics | 128-37-0 | A0295070 |
| Water (Deionized, Ultra filtered) | Fisher Scientific | 7732-18-5 | 133687 |
| Xylenol orange disodium salt | Fluka Analytical | 1611-35-4 | BCBH9921V |
| Isopropanol | J.T. Baker | 67-63-0 | 0000045208 |
| Ferrous ammonium sulfate hexahydrate | Fisher Scientific | 7783-85-9 | 107682 |
| AlkaSafe Std Reagent A | MP Biomedicals | | Alk0214 |
| AlkaSafe Std Reagent B | MP Biomedicals | | Alk0214 |

Data Analysis.

This was exploratory research aiming at screening for possible natural A/O that can replace EDTA. Therefore only one replicate of each batch was completed at this time. However, the trend of the treatments over time was studied and used to compare samples to one another.

### Results

Comparisons of Oxidative Products Among Treatments.

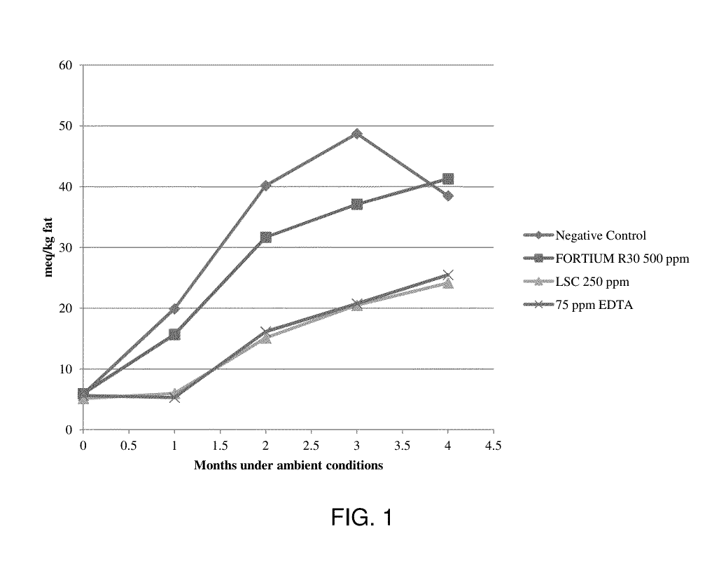

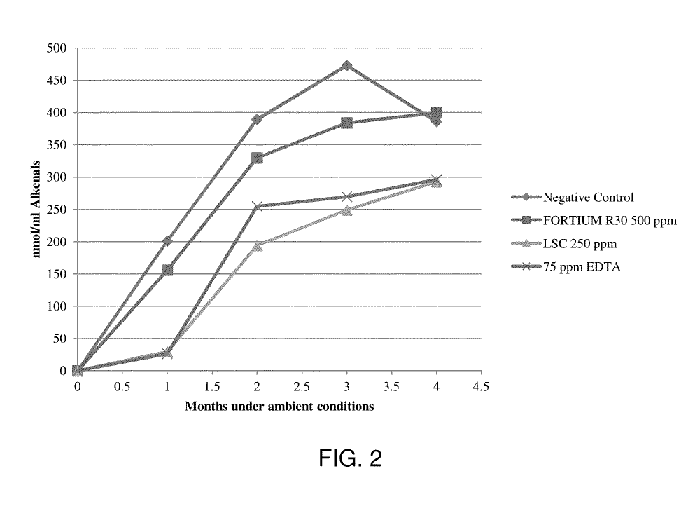

Both the PVs and alkenals indicated that the untreated control appeared to be the most oxidized sample from months 1-4 (FIG. 1 and FIG. 2). Mayonnaise treated with 500 ppm R30 appeared to be less oxidized than the untreated control. However, there were still higher amount of oxidative products than the positive control, EDTA (75 ppm). However, for PV, LSC at 250 ppm was as efficacious as EDTA (FIG. 1), and for alkenals the trend suggested that it was more efficacious than EDTA (FIG. 2) numerically.

### Discussion

EDTA is a widely used synthetic chelator which acts as antioxidant in mayonnaise. However it is typically not considered to be label-friendly. The level of 75 ppm was chosen because it was the highest allowed level of EDTA for mayonnaise in the United States, and therefore represents the gold standard of oxidation control in mayonnaise.

After 4 months of ambient storage, the results from this study showed that the mayonnaise treated with 250 ppm LSC was the least oxidized sample with comparable performance to EDTA. The PVs were very similar to EDTA throughout the study, and the alkenals values of the LSC sample were very similar to the EDTA sample from months 0-1, but actually appeared slightly lower than the EDTA sample from months 2-3. Naturally derived LSC at 250 ppm is an excellent alternative to EDTA.

### Example 3

### Cereals

Although relatively low in fat, ready to eat cereals are still subject to oxidative rancidity. The objective of this study was to treat extruded cereal with various combinations of ingredients and compare to untreated (negative control), butylated hydroxyl toluene (BHT) (synthetic positive control) and FORTIUM®_{brand} MT70 (mixed tocopherols) (naturally derived positive control). Samples were stored under accelerated conditions (40° C.). The primary factors influencing the shelf life of cereal are oxidative by-products (peroxide value −PV), volatile secondary oxidative by-products (hexanal) and most importantly, sensory attributes (aroma and flavor). The accumulation of oxidation products was monitored instrumentally by testing peroxide values (PV), and hexanals. Changes in the sensory attributes of aroma and flavor were also monitored. Both chemical evaluation and sensory evaluation showed an improvement over the untreated control when antioxidant combinations including spearmint extract (SE) and lipid soluble catechins (LSC) were used, indicating that the combination of natural or natural derived ingredients may be effective stabilizers of extruded cereal.

### Materials and Methods

The raw materials used in the production of the cereal are shown in Table 11.

TABLE 11
Ingredients and formula for extruded cereal

| Target % | | | |
|---|---|---|---|
| (of Dry | Weight actually | | |
| mix) | added (lbs) | Ingredient | Supplier |
| 60 | 350.0 | Whole flour | 21st Century |
| 35 | 204.2 | Native corn starch | KPC 13700 |
| 4 | 23.3 | Granulated sugar | United Sugars Corp |
| 1 | 5.8 | Fine flake salt | Cargill |
| N/A | 135.0 g | Canola oil, Lot | Kemin Animal Nutrition |
| | per batch | #1312111714 | and Health (RM07794) |

Products used for treatment of the cereal are shown in Table 12.

TABLE 12
Treatments used in the extruded cereal

| | | | | Weight added |
|---|---|---|---|---|
| | | | | to |
| | | | | each batch |
| Antioxidant | Lot # | Supplier | Item/RM # | (g) |
| FORTIUM ®_{brand} MT70 | 1310109865 | Kemin Food | 016242 | 15.12 |
| | | Technologies | | |
| EN-HANCE ®_{brand} BHT | 1203101564 | Kemin Food | 01014 | 1.89 |
| | | Technologies | | |
| Verdilox ™ GT Liquid | 1306103671 | Kemin Nutrisurance | S016989 | 28.35 |
| Spearmint Extract | 1402101496 | Kemin Food | 01680 | 9.92 |
| FORTRA ®_{brand} | | Technologies | | |
| FORTIUM ®_{brand} MT95 | 1307109107 | Kemin Food | 15515 | 4.25 |
| Liquid | | Technologies | | |
| ROSAN SF35 Liquid | 1309100564 | Kemin Food | 015425 | 4.82 |
| | | Technologies | | |

Treatment levels are shown in Table 13. Two positive controls were used. BHT which is a commonly used synthetic antioxidant in extruded cereals and mixed tocopherols which are natural derived and routinely used in cereals. The dosage of BHT was based on the upper legal limit allowed in cereals. The dosage for the mixed tocopherols (FORTIUM®_{brand} MT70) was chosen based on a previous study which has shown that 400 ppm of mixed tocopherols, MT70, were effective in delaying oxidation in extruded cereals. Verdilox GT Liquid (Kemin Industries, Inc., Des Moines, Iowa) is a potent formula effective in delaying fat oxidation in extruded pet kibbles. It was applied in this study in order to evaluate its efficacy in extruded food that is for human consumption. Lipid soluble catechins (LSC) are the esterified form of water soluble catechins and have shown to be effective in delaying oxidation in fats and oils. It is one of the components in Verdilox GT Liquid. Spearmint extract (SE) is a water soluble ingredient which has shown to be effective in delaying milk fat oxidation in liquid and powdered milk. The formula for Tocopherols+SE+Rosemary extract (TRS) was adapted from previous study in milk fat stabilization.

TABLE 13
Treatment levels (ppm) in extruded cereal. SE = Spearmint extract.

| Code | MT70 | Verdilox GT | Rosan SF35 | MT95 | SE | BHT |
|---|---|---|---|---|---|---|
| Unt | | | | | | |
| MT70 | 400.0 | | | | | |
| Verdilox | | 750.0 | | | | |
| Verdilox + | | 750.0 | | | 40.0 | |
| SE | | | | | | |
| TRS | | | 127.5 | 112.5 | 40.0 | |
| BHT | | | | | | 50.0 |

Methods.

A total of 12 batches (45 lbs each) of cereal were extruded at the University of Nebraska-Lincoln pilot plant. Two batches (n=2) were made for each treatment group. The cereal was produced using a Wengert TX-57 Twin Screw extruder (Wengert Manufacturing, Sabetha, Kans.). The dry mixture was blended in a large master batch, then separated/divided into 45 lb batches. All treatments (with the exception of the SE) were mixed into 135 grams of oil. Four pounds of the dry blend was removed from each 45 lb batch, the oil added and mixed by hand until well blended. This mixture was added back to the rest of the dry blend and mixed for 10 min using a blender. The SE was dry blended into 1 lb of dry mix, which was then combined with the rest of the dry blend. Extrusion of each sample lasted 17 minutes, including 9 minutes of flushing clean material through. The cereal that was extruded during the flushing period was not collected in order to minimize cross contamination between batches. Following extrusion, samples were packed ˜100 g per low-density polyethylene (LDPE) cereal bag and heat sealed. One sample of each was transported back to the lab to be analyzed the next day, and remaining bags (24 of each group) were shipped a few days later.

Samples were evaluated every 10 days for 155 days. At day 50 testing frequency was reevaluated and changed to every 2-3 weeks due to the observations that the oxidative byproducts remained low in the first portion of the study. At each time point, one bag from each batch was opened for sensory and instrumental analysis. The time points for the cereal stored testing were day 1 of ambient conditions (“day 0” on the graphs), and days 9, 20, 30, 40, 50, 71, 92, 113, 134, 155.

Peroxide Values and Hexanal Analysis.

The cereals were analyzed for primary oxidation products (PV) and secondary oxidation products (hexanal). Hexanals were chosen as it has been shown to be a good parameter which has positive correlation with the sensory change of extruded cereals. Hexanal was determined internally using GC analysis following established procedures.

Data Analysis.

The comparisons of carnosic acid and pH values for all samples were performed by Analysis of Variance (ANOVA) using STATGRAPHICS Centurion XV software package.

Sensory Analysis.

Sensory evaluation was performed on replicated cereal samples. Sensory panelists attended 2-30 min training sessions to familiarize them with the 2 attributes of interest (oxidized aroma and oxidized flavor). One ounce plastic sample cups (Daily Chef, Bentonville Ark.) were filled approximately ½ full with cereal and sealed with plastic lids. For training, panelists were provided with examples labeled as none, medium or extreme oxidized aroma and flavor. They were asked to rate the samples on a 15 cm line where none=0 and 15=extreme. The mark on the line scale represented the perceived intensity of the attribute. Panelists were instructed on the proper procedure for evaluating both aroma and flavor. Aroma was evaluated first with the panelists instructed to shake the sealed sample, then slightly open the sample and sniff. A plain white paper napkin was supplied and panelists instructed to sniff the napkin between samples to clear the aroma from their noses. For flavor evaluation panelists were instructed to taste the sample, determine the rating then take a sip of water and a bite of unsalted cracker between samples. After a group discussion about the samples, the panelists were provided with blindly labeled samples of the same examples and asked to rate the samples, with the objective being a similar rating as the labeled samples. For the storage study sensory evaluation samples were labeled with 3 digit random codes. Cups were filled with approximately 1 gram of cereal and sealed with lids. Panelists were provided with a labeled sample that was considered a medium reference for both oxidized aroma and flavor. Panelists were instructed to evaluate the samples using the procedure used during training.

### Results

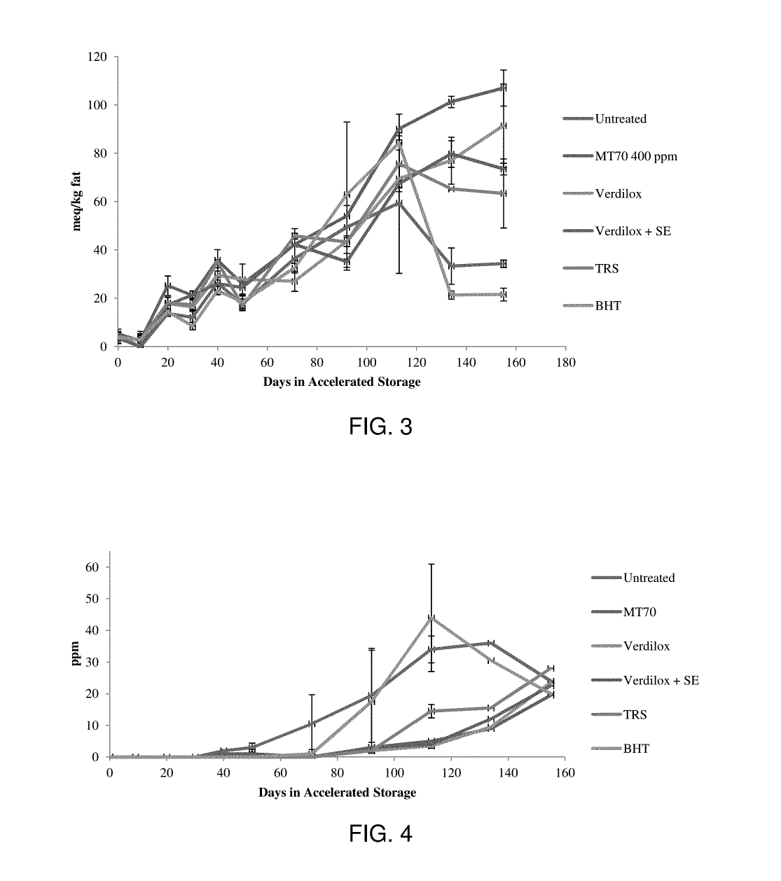

PV results are shown in FIG. 3. Data separation among treatments was not apparent until later in the storage period. PV in FORTIUM®_{brand} MT70 treated cereals kept increasing and numerically was higher than other treatments in the end. However PV in other treatments, with the exception of Veridlox, reached a peak and declined towards the end of accelerated storage time. For example, BHT treated increased until day 113, then experienced a substantial drop.

From FIG. 4, hexanal contents started to accumulate after day 70 of storage time. With the exception of day 113, the untreated had numerically higher hexanal content than other treatment until day 155, at which point the hexanals started to decline. Hexanal content in BHT treated cereal had started to increase after day 70 and started to decline after day 113. The combination of mixed tocopherols, spearmint extract and rosemary extract (TRS) was still effective in maintaining lower hexanal content when compared to the untreated control. Verdilox GT, Verdilox GT+spearmint extract and MT70 had lowest amount of hexanal until day 134. And it seemed that the addition of spearmint extract to Verdilox GT (Verdilox+SE) didn't have further benefit in maintaining lower hexanal content when compared to Verdilox GT treatment alone.

Sensory evaluation results are shown in Tables 15 and 16. A higher number indicates a higher intensity of oxidized aroma or flavor. Oxidized aroma scores showed significant differences between some treatments at days 10, 40, 70, 113, 134 and 155. At the final test period (day 155) there was a significant difference (p<0.05) between the untreated cereal and the cereal treated with BHT. Oxidized flavor scores showed significant differences between treatments at days 92-155. At day 113 MT70, Verdilox and TRS had significantly lower oxidized flavor scores than untreated or BHT treated samples. At day 134, all samples had significantly lower oxidized flavor scores than the untreated sample. By day 155, the differences between treatments became less apparent.

TABLE 15
Scores for oxidized aroma for cereals at accelerated storage condition (40° C.). Means
within a column with different superscripts are significantly different (p < 0.05)

| | Days in Accelerated Storage | | | | | | | | | | |
|---|---|---|---|---|---|---|---|---|---|---|---|
| | 0 | 10 | 20 | 30 | 40 | 50 | 70 | 92 | 113 | 134 | 155 |
| Untreated | 1.62 | 1.96^{b} | 2.24 | 1.77 | 1.89^{c} | 2.33 | 4.44^{b} | 4.93 | 4.08^{cd} | 4.96^{b} | 3.72^{b} |
| BHT | 1.04 | 1.31^{ab} | 1.88 | 1.24 | 1.65^{bc} | 1.64 | 1.88^{ab} | 4.71 | 5.51^{d} | 2.22^{a} | 2.02^{a} |
| MT70 | 1.21 | 1.64^{b} | 2.09 | 1.34 | 1.32^{ab} | 1.28 | 1.46^{ab} | 1.63 | 1.97^{a} | 3.07^{a} | 2.73^{ab} |
| Verdilox + | 1.42 | 1.76^{b} | 1.68 | 1.30 | 1.03^{a} | 1.19 | 1.69^{ab} | 1.68 | 3.81^{bcd} | 3.55^{ab} | 3.81^{ab} |
| SE | | | | | | | | | | | |
| Verdilox | 1.65 | 1.53^{ab} | 1.64 | 1.37 | 1.60^{ab} | 1.59 | 1.42^{ab} | 1.97 | 2.41^{abc} | 3.29^{ab} | 4.13^{ab} |
| TRS | 1.48 | 0.88^{a} | 1.68 | 1.37 | 1.47^{b} | 1.17 | 1.18^{a} | 1.32 | 2.23^{ab} | 3.59^{ab} | 3.01^{ab} |

TABLE 16
Scores for oxidized flavor for cereals at accelerated storage condition (40° C.). Means
within a column with different superscripts are significantly different (p < 0.05)

| | Days in Accelerated Storage | | | | | | | | | | |
|---|---|---|---|---|---|---|---|---|---|---|---|
| | 0 | 10 | 20 | 30 | 40 | 50 | 70 | 92 | 113 | 134 | 155 |
| Untreated | 1.35 | 1.22 | 1.77 | 1.54 | 1.55 | 2.02 | 3.11 | 4.56^{b} | 4.03^{b} | 6.67^{b} | 4.82^{b} |
| BHT | 0.96 | 1.96 | 1.90 | 1.36 | 1.53 | 1.41 | 1.36 | 3.28^{ab} | 4.32^{b} | 2.06^{a} | 1.90^{a} |
| MT70 | 1.40 | 2.23 | 1.73 | 1.57 | 1.26 | 1.16 | 1.54 | 1.40^{a} | 2.10^{a} | 2.17^{a} | 2.81^{ab} |
| Verdilox + | 1.50 | 1.42 | 2.04 | 1.57 | 1.12 | 1.23 | 1.50 | 1.29^{a} | 3.34^{ab} | 2.31^{a} | 3.89^{ab} |
| SE | | | | | | | | | | | |
| Verdilox | 1.67 | 1.55 | 1.81 | 1.81 | 1.49 | 1.34 | 1.72 | 1.14^{a} | 1.99^{a} | 2.45^{a} | 3.68^{ab} |
| TRS | 0.94 | 1.63 | 1.46 | 1.70 | 1.69 | 1.21 | 1.35 | 1.18^{a} | 1.81^{a} | 3.56^{a} | 3.29^{ab} |

### Discussion

PVs, hexanals, oxidized aroma and oxidized flavor all correlated for the BHT treated samples from days 113 to 155 reaching the highest concentration at day 113 and declining at day 134 and 155. It is possible that at day 113, PV accumulation in BHT and untreated cereals had reached a peak and peroxide decomposition started to dominate. Decomposition of peroxides would produce secondary oxidation products which have direct correlation with the flavor and odor changes of cereals. Hexanal values between 5 and 10 ppm have been shown to correlate with oxidized aroma in low fat dry foods. Hexanal values started to increase after day 113 at which point the oxidized aroma scores also increased. For most samples, hexanal did not begin to form until between days 70 and 92. It is possible that at this time, further oxidation started to dominate which would consume some of the unstable hexanal. The pattern of hexanal change was very different for BHT samples than from all the other treatments so it is possible that oxidation pathway is different in BHT treated samples.

### Example 4

### Effects of Antioxidants on the Oxidative Stability of Margarine at Elevated Storage Temperature

Margarine with around 80% fat content was treated with various natural or synthetic ingredients to test the antioxidative effects. Lipid soluble green tea extract (LSC) was the best in producing the least amount of oxidative products over the storage time in margarine. It could be used as the natural alternative to synthetic antioxidant BHA/BHT in margarine.

### Materials and Methods

Materials and chemicals. EN-HANCE®_{brand} BHA dry, EN-HANCE®_{brand} BHT dry, FORTIUM®_{brand} MT90, lipid soluble green tea (LSC, or EN-FORT™101 Dry), FORTIUM®_{brand} R20 (rosemary extract/sunflower oil), FORTIUM®_{brand} R40 (rosemary extract/sunflower oil), ascorbic acid (VC) and sodium caseinate (SC) were provided by Kemin Food Technologies (Zhuhai, China). Raw oil (melting point at 38-42° C.) was provided by Wilmar (Qihuangdao, China), which contained palm oil, soybean oil, unknown emulsifier, flavor and pigment at unknown ratios. The resulted margarine was composed of 84% raw oil and 16% distilled water.

Xylenol orange disodium salt (indicator grade), ammonium iron (II) sulfate hexahydrate (AR, 99.5%), p-anisidine (99%), sulfuric acid (98%), glacial acetic acid (99.5%), hydrogen peroxide (AR, 30% in water), isopropanol (HPLC grade, 99.8%), iso-octane (HPLC grade, 99.0%) were purchased from Aladdin Reagents Inc. (Shanghai, China).

Sample Preparation.

Raw oil was melted completely at 60° C. in a water bath, and was treated with the following ingredients, separately: (1) untreated control, (2) 84 ppm EN-HANCE BHA+84 ppm EN-HANCE BHT (positive control 1), (3) 100 ppm FORTIUM®_{brand} MT90 (mixed tocopherols) (positive control 2), (4) 125 ppm LSC (LSGT), (5) 250 ppm LSC, (6) 500 ppm FORTIUM®_{brand} R20, (7) 1000 ppm FORTIUM®_{brand} R20, (8) 200 ppm VC+250 ppm FORTIUM®_{brand} R40, (9) 200 ppm VC+250 ppm FORTIUM®_{brand} R40+50 ppm SC. Application rates were based on total weight of margarine (Treatment 3-9) and on total fat content of margarine (Treatment 2). The treatments were not replicated.

Margarine was emulsified by pouring heated distilled water (60° C.) into the raw oil and the mixture was homogenized in a high speed blender for 30 minutes. The homogenized mixture was kept in a freezer at −18° C. and was manually stirred occasionally to be solidified (about 30-40 minutes). Each treatment was divided into 6 portions. Each portion was placed in a 50 ml transparent polyethylene conical centrifuge tube (Fisher Scientific Pte Ltd, China) and stored in an oven without light exposure at 35° C. for 6 weeks storage study. At each testing point, 2 portions of 5 gram samples were taken out of one 50 mL tube for analysis for each treatment.

Chemical Analyses.

Peroxide values (PV, primary oxidative byproducts) in margarine were measured using FOX II (ferrous oxidation in xylenol orange) method (000-KNCLSM-017) on a Shimadzu UV-2401PC spectrophotometer. p-Anisidine values were measured according to the AOCS Official Method Cd 18-90 (050KFTWW-M.062). The absorbance at 350 nm was measured (A_{b}) on the same Shimadzu UV-2401PC spectrophotometer using iso-octane as blank. Each measurement was duplicated.

Data Analysis.

Multiple regression analyses on peroxide values and p-anisidine values among different treatments were conducted using STATGRAPHICS® Centurion XV software package.

### Results

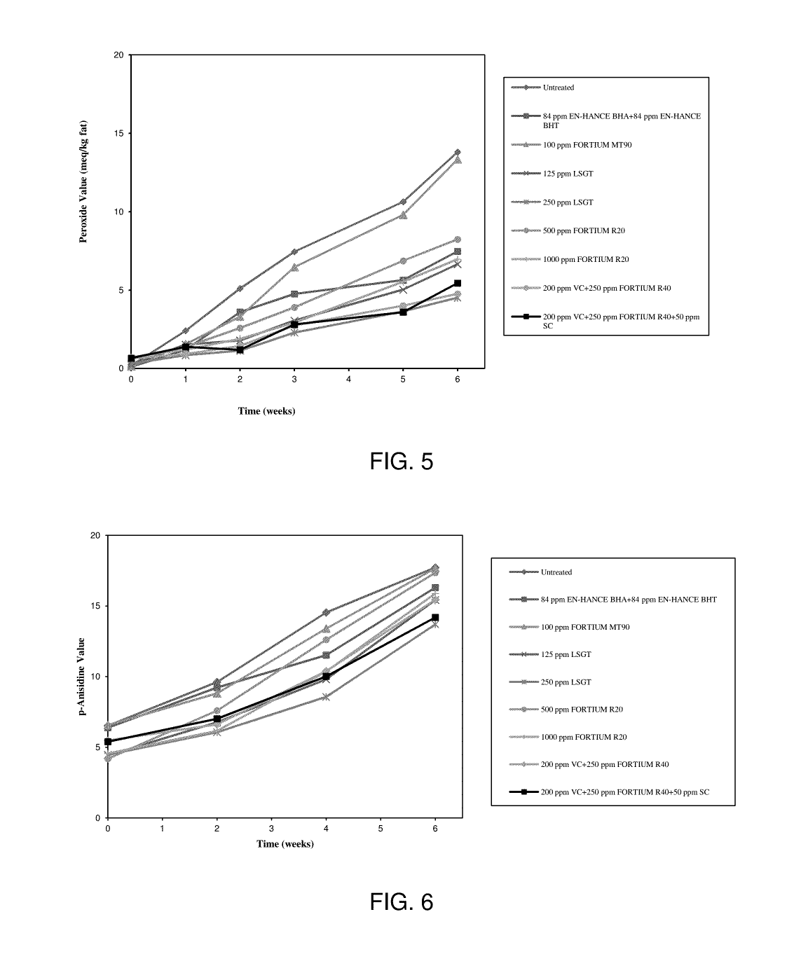

PV in untreated and FORTIUM®_{brand} MT90 treated margarine increased rapidly during storage at 35° C. (FIG. 5). FORTIUM®_{brand} MT90 and untreated control had similar peroxide values. All other treatments were able to delay the accumulation of peroxides, which remained below the threshold level (10 meq/kg fat) during the storage period. Food is generally considered to have rancidity problem if the PV is above the threshold level.

LSC at 250 ppm and the two treatments which contained FORTIUM®_{brand} R40 outperformed the combination of EN-HANCE BHA and EN-HANCE BHT (positive control 1) (FIG. 5). LSC at 125 ppm and FORTIUM®_{brand} R20 at two dosage levels performed similarly to positive control 1. With or without 50 ppm SC, the two treatments containing VC and FORTIUM®_{brand} R40 developed similar peroxide values during the whole storage period.

p-Anisidine values also increased over the storage period for all treatments (FIG. 6). Comparison of the slopes and intercepts of the individual regression lines revealed that LSC, FORTIUM®_{brand} R20 and VC+FORTIUM®_{brand} R40 treatments had lower p-anisidine values than the untreated. Anisidine values in the EN-HANCE BHA+EN-HANCE BHT treatments (positive control 1) were also lower than the untreated. FORTIUM®_{brand} MT90 at 100 ppm was not effective in lowering p-anisidine values comparing the untreated.

Treatments with 125 and 250 ppm LSC, 1000 ppm FORTIUM®_{brand} R20 and 200 ppm VC+250 ppm R40+50 ppm SC outperformed FORTIUM®_{brand} MT90 treatment. Treatments with 500 ppm FORTIUM®_{brand} R20 and 200 ppm VC+250 ppm R40 had lower anisidine values than sample treated with 100 ppm FORTIUM®_{brand} MT90.

Compared to 84 ppm, EN-HANCE BHA+84 ppm EN-HANCE BHT, LSC had better performance when it was dosed at 125 ppm. It had significantly higher efficacy in maintaining lower anisidine values when the dosage increased to 250 ppm. Meanwhile, treatment with 200 ppm VC+250 ppm R40+50 ppm SC had a trend maintaining lower anisidine value comparing to BHA+BHT treatment. With or without 50 ppm SC, there was no performance difference between the two treatments which contained 200 ppm VC+250 ppm R40.

### Discussion

The abilities of a few ingredients to protect margarine against lipid oxidation were identified in this study. There was a clear trend over the storage time. LSC treatments (125 and 250 ppm), 1000 ppm FORTIUM®_{brand} R20 treatment and VC+FORTIUM®_{brand} R40 treatments were able to delay the accumulation of primary and secondary oxidative by-products in the margarine as suggested by the peroxide and p-anisidine values. In addition, the positive control, FORTIUM®_{brand} MT90, did not show much efficacy in protecting the margarine against oxidative rancidity although mixed tocopherols are widely used in the margarine industry. The other positive control, the combination of EN-HANCE BHA+EN-HANCE BHT, could protect margarine effectively with significantly lower peroxide value and numerically lower anisidine value than the untreated sample.

Comparing to FORTIUM®_{brand} MT90, both 125 and 250 ppm LSC, 1000 ppm FORTIUM®_{brand} R20 and 200 ppm VC+250 ppm R40+50 ppm SC treatments displayed significant efficacy in protecting the oxidative stability of margarine. LSC at 250 ppm outperformed 84 ppm EN-HANCE BHA+84 ppm EN-HANCE BHT with lower primary and secondary oxidative products. Sodium caseinate (SC) is a milk protein and is widely used as a metal chelator, which could potentially chelate heavy metal catalyst for lipid oxidation. In this study, with or without 50 ppm SC, there was no difference between the two treatments containing 200 ppm VC+250 ppm FORTIUM®_{brand} R40.

As BHA and BHT are both synthetic chemicals, LSC, a natural product based ingredient, could serve as an alternative ingredient to the BHA+BHT combination in maintaining the oxidative stability of margarine. Additionally, this study showed that LSC/rosemary extract maintained better oxidative stability than mixed tocopherols, for margarine, and could therefore act as a solution as a tocopherols replacement in margarine.

### Example 5

### Oxidative Stability of Salad Ranch Dressing by Various Treatments

Due to the high fat content, salad dressings are susceptible to lipid oxidation, which reduces the shelf life. Volatile compounds that are formed from secondary oxidative byproducts contribute to flavor quality and in turn off flavors and odors. Ethylenediaminetetraacetate (EDTA) is typically used to delay oxidation in salad dressing since it is inexpensive and highly effective at the maximum permitted dose of 75 ppm. However, there is increased consumer demand for natural products, and many companies are interested in natural alternatives to EDTA. The objective of this study was to compare Kemin Food Technologies (KFT) GT-FORT™ 101 (lipid soluble green tea/sunflower oil) (GTF), FORTIUM®_{brand} R30 (rosemary extract) (R30) and combinations of the two in delaying oxidative rancidity in a ranch salad dressing.

### Materials and Methods

Materials.

Materials used in the preparation of the salad dressing are shown in Tables 17 and 18. GT-FORT 101 SF and R30 were obtained from KFT Customer Laboratory Services (CLS). EDTA was obtained from Premium Ingredients (Carol Stream, Ill.).

TABLE 17
Raw materials used in the preparation of ranch salad dressing

| Ingredient | Percent | Supplier | Location |
|---|---|---|---|
| Soybean oil | 56.00 | *KANA | Des Moines, IA |
| Water | 25.89 | Crystal Clear | Des Moines, IA |
| Ranch dressing seasoning | 8.71 | Elite Spice | Jessup, MD |
| White vinegar | 5.90 | *KANA | Des Moines, IA |
| (dilute to 120 grain) | | | |
| Egg yolk (10% salt) | 3.50 | Oskaloosa Egg | Oskaloosa, IA |
| Potassium sorbate | 0.025 | Prinova | Carol Stream, IL |

*Kemin Animal Nutrition and Health

TABLE 18
Inclusion level of treatments in ranch salad dressing (ppm).
The dosages are based on total weight of the dressing.

| Treatment | GT-FORT 101 SF | R30 | EDTA |
|---|---|---|---|
| # | (20140716-01) | (20140703-01) | (C060131) |
| 1 | — | — | — |
| 2 | | | 75 (0.3 g) |
| 3 | 1250 | | |
| 4 | 600 | | |
| 5 | | 600 | |
| 6 | 600 | 100 | |
| 7 | 600 | 250 | |
| 8 | 600 | 400 | |
| 9 | 600 | 600 | |
| 10 | 800 | 250 | |
| 11 | 1000 | 250 | |
| 12 | 1250 | 250 | |

Mixing Instructions.

Ranch dressing was prepared using a KitchenAid® mixer (325 watt, St. Joseph, Mich.) with the paddle attachment. For each of the 12 batches, 400 grams were prepared. The eggs were weighed into a stainless steel bowl and beat on low setting (#2) for 30 seconds. The mixer was stopped and the sides of bowl were scraped with a rubber spatula to incorporate any of the mixture on the sides of the bowl. Mixture was beat for additional 30 seconds on speed #2. Potassium sorbate was dissolved in the water which was then added and mixed for 30 seconds on speed #2, bowl was scraped, and mixed an additional 30 seconds on speed #4.

Oil was added very slowly over the course of 5 minutes, while the mixer was mixing at speed #4. After oil was added, the vinegar was added over the course of 30 seconds while the mixer was mixing at speed #4. Mixer was stopped and ranch dressing seasoning added in one portion and then mixed for 30 seconds on speed #4. Mixture was then transferred to a food processor (Black and Decker, USA) and blended for 30 seconds.

Storage Conditions.

Samples were packaged into individual 2 ounce PET bottles (Fisher Scientific item 02991683) to allow for a different sample to be opened at each test period. Samples were stored at accelerated temperature (40° C.).

Stability Analysis.

Samples were analyzed for alkenal values (secondary oxidative byproducts) and peroxide values (PV).

### Results

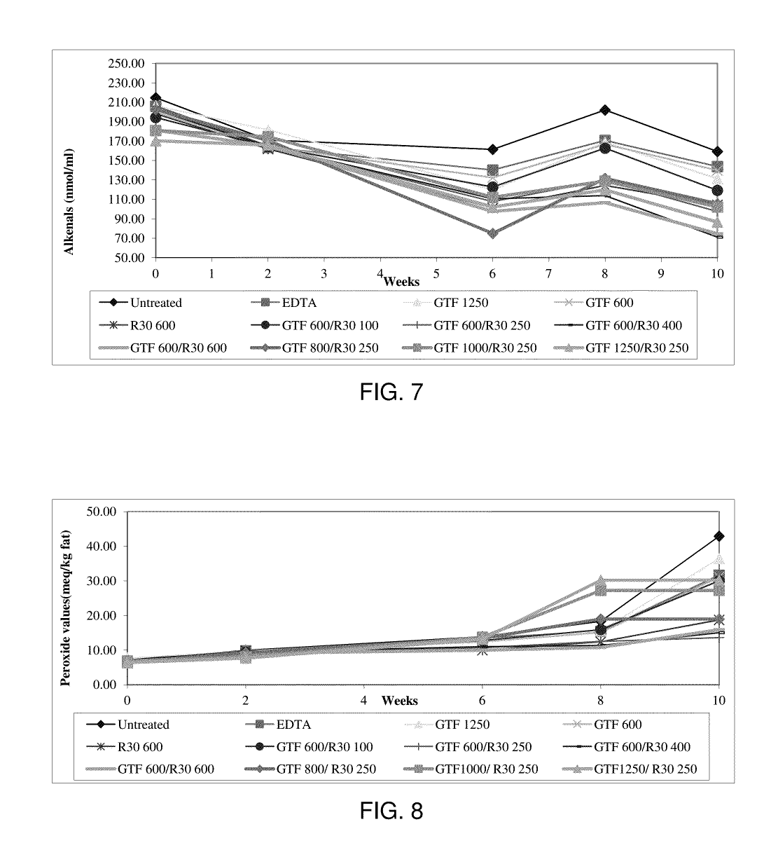

The results of the oxidative byproduct testing are shown in FIGS. 7 and 8. Obvious data separation started from week 6. The untreated sample had the highest in PV, starting at week 2, and alkenals, starting at week 6. The alkenals were the lowest for the GTF/R30 600/400 and 600/600 at week 10. EDTA treated samples overall resulted in the second highest alkenals levels. Addition of either rosemary, GTF or the combination resulted in lower alkenals. Combinations all resulted in lower alkenal values.

For PV, the data separations for each treatment were more pronounced toward the later stages of the study. The combination samples of GTF/R30 600/250, 600/400 and 600/600 had the lowest PV at week 10. The endpoint or acceptability limit for soybean oil (used in this matrix) is 10 meq/kg fat. By week 10 all samples were above this limit.

Combining both PV and alkenals, GTF 600 ppm combined with various levels of rosemary resulted in lowest oxidative products in this ranch dressing.

### Example 6

### Emulsification Properties of LSC at the Interface

### Materials and Methods

Materials.

Sorbitan monooleate (span 80), triglycerol dioleate (TGDO), lipid soluble green tea (LSC, lot #1401101795, Kemin Bioscience, Ningbo, China), sodium chloride (99.5%), ultrapure water, soybean oil (bought from local supermarket). Span 80, TGDO and sodium chloride were bought from Aladdin Reagent, Shanghai, China.

Stability Test of LSC Treated Soybean Oil/Water Emulsions.

The stability of soybean oil/water emulsions were evaluated by measuring the time course of the volume fraction of the emulsion phase at 25° C. An oil-in-water emulsifier, like Span 80, TGDO or LSC (0.50 g), was first dissolved in 50 mL soybean oil in a 250 mL beaker. It was necessary to heat the soybean oil to 80-90° C., in order to assist the dissolution of LSC. A portion of 50 mL brine (15% sodium chloride in ultrapure water by weight) was then added. The biphasic solution was homogenized at 17,500 rpm for 2 minutes using an IKA Ultra Turrax T25 basic homogenizer. The resulting emulsion was then immediately transferred to a 100 mL graduate cylinder. The emulsion then began to separate, with the emulsion phase on the top and the aqueous phase on the bottom. The volume of the emulsion phase was recorded after 5 min, 10 min, 30 min, 60 min and 24 h of separation. Each treatment (span 80, TGDO, LSC and untreated) was conducted in triplicate. The volume fraction of the emulsion phase was calculated by dividing the volume of emulsion phase (mL) by total volume of water and oil (100 mL).

Enhanced Stability of Food Emulsion.

Salad dressing and mayonnaise were made according to the recipe in Table 19 and Table 20.

Ranch dressing was blended using a KitchenAid® mixer with the paddle attachment. The eggs were weighed in the stainless steel bowl and beat on low setting (#2) for 30 seconds. The sides of the bowl were scraped and the eggs were beat for another 30 seconds. Water was added and then mixed for 30 seconds, the bowl was scraped, and then mixed an additional 30 seconds at speed setting #4. On speed setting #4, the oil was added very slowly. After the oil was added, vinegar was added over the course of 30 seconds at speed setting #4. The ranch dressing seasoning mix was then added and mixed for 30 seconds on speed setting #4. The mixture was transferred to a food processor and blended for 30 seconds.

To make the mayonnaise, the egg yolks were first whipped in a KitchenAid® mixer (Heavy Duty) using the wire whip attachment for 30 seconds on speed setting #2. Salt and mustard were then added, and mixed for an additional 30 seconds on speed setting #4, scraping the sides with a spoon 3 times. The water was then added and mixed for 30 seconds on speed setting #2, then scraped, then mixed for another 30 seconds on speed setting #4. The oil was then added on speed setting #4 very slowly, in small increments (especially at first, when only a few mL is added and allowed to absorb in the eggs before adding more). For this amount of mayonnaise, about 15 minutes total time was required to add the oil. Towards the end it was added in a slow stream. Once all the oil was added, the vinegar was added over 30 seconds on speed setting #2. It was then mixed for an additional 30 seconds, alternating between speed settings #2 and #4. The total mixing time is 5-10 minutes.

Salad dressing and mayonnaise were frozen in −20° C. for overnight and thawed in 60° C. water bath for 1 hour.

TABLE 19
Ranch dressing formula.

| Item number | Material | % |
|---|---|---|
| RM01320 | Soybean oil | 56.00 |
| Crystal Clear ® | Water | 25.89 |
| Elite Spice 31017A9 | Ranch dressing seasoning | 8.71 |
| Version 1 | | |
| RM16833 | White vinegar (diluted to 120 grain) | 5.90 |
| Oskaloosa Egg | Egg yolk (10% salt) | 3.50 |

TABLE 20
Mayonnaise formula per batch.

| Ingredient | Target % | Mass added |
|---|---|---|
| Soybean oil | 75.00 | 1125 ± 0.05 g |
| Salt | 0.61 | 9.18 ± 0.01 g |
| Egg yolks, 10% salt | 8.89 | 133.32 ± 0.05 g |
| Ground mustard | 1.00 | 15 ± 0.01 g |
| Heinz ® distilled white vinegar | 12.60 | 189 ± 0.01 g |
| Water | 1.90 | 28.5 ± 0.01 g |

### Results

Comparison to Other Emulsifiers.

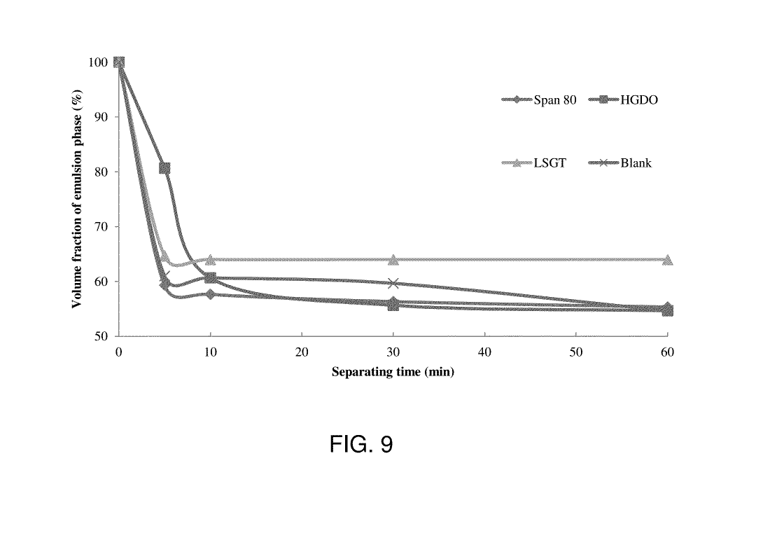

A graph of emulsion volume fraction over separating time was drawn in FIG. 9. It shows that within 10 minutes separation, the volume of emulsion phase for HGDO and LSC treatments decreases slower than the untreated. However, after 10 minutes separation, only LSC treated emulsion stayed at consistent higher emulsion volume (64%) whereas the emulsion volume for all other treatments drops down to 55% at the time point of 60 minutes separation. The volume fraction of emulsion phase then keeps unchanged for all treatments even after 24 hours. The results reveal that LSC helps stabilize oil-in-water emulsion and LSC has better emulsifying ability than two commonly used oil-in-water emulsifiers—span 80 and HGDO in the soybean oil/water emulsions.

Emulsion Stability in Food Emulsion.

For both food emulsions, treated ranch dressing and mayonnaise, the LSC treated samples were physically more stable, that only one phase was present after the abusive freeze and thaw cycle, which would normally break the emulsion and result in two phases (water and oil phases).

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A method of delaying oxidation in food products having a lipid and water phase interface, comprising the step of adding an efficacious amount of tea catechins esterified to esters.

2. The method of claim 1, wherein the food product is meat and the method results in a delay in undesirable color changes in the meat.

3. The method of claim 1, wherein the food product is meat and the method extends the oxidative stability of the meat.

4. The method of claim 1, wherein the food product is selected from the group consisting of food emulsions.

5. The method of claim 4, wherein the food emulsion is selected from the group consisting of mayonnaise, margarine, and salad dressing.

6. The method of claim 1, wherein the food product is selected from the group consisting of fats and oils.

7. The method of claim 6, wherein the oil is selected from the group consisting of vegetable oils.

8. The method of claim 1, wherein the food product is selected from the group consisting of extruded foods.

9. The method of claim 8, wherein the extruded food is selected from the group consisting of ready-to-eat cereals.

10. The method of claim 1, wherein the esters comprise palmityl esters.

11. The method of claim 1, wherein the efficacious amount is between 10 ppm and 5,000 ppm by weight of the food product.

12. The method of claim 11, wherein the efficacious amount is between 100 ppm and 1,000 ppm.

13. The method of claim 1, further comprising adding an antioxidant compound to the food product.

14. The method of claim 13, wherein the antioxidant compound is selected from the group consisting of BHA, BHT, tert-butlyhydroquinone, gallates, ascorbic acid, erythorbic acid, ascorbyl palmitate, tocopherols, tocotrienols, carotenoids, anthocyanins, polyphenols, citric acid, ethoxyquin, EDTA, glycine, lecithin, polyphosphates, tartaric acid, trihydroxybutyrophenone, thiodipropionic acid, and dilauryl and distearyl esters.
